(19) United States
(12) Patent Application Publication
(10) Pub. No.: US 2002/0113551 A1
(43) Pub. Date: Aug. 22, 2002

(54) Light conversion and detection of visible light

(76) Inventors: Tom Francke, Sollentuna (SE); Vladimir Peskov, Stockholm (SE); Igor Rodionov, Moskow (RU); Tatiana Sokolova, Moscow (RU)

Correspondence Address: BIRCH STEWART KOLASCH & BIRCH, PO BOX 747, FALLS CHURCH, VA, 22040-0747, US

(21) Appl. No.: 09/816,322

(22) Filed: Mar. 26, 2001

(30) Foreign Application Priority Data
Feb. 19, 2001 (SE) 0100544-6

(51) Int. Cl. H01J 40/06

(52) U.S. Cl. 313/542

(57) ABSTRACT

The present invention relates to an apparatus (11) for conversion of visible light to UV light, and includes an entrance window (17) transparent to visible light; a photocathode (23) adapted to release photoelectrons in dependence on being irradiated by visible light; an electrode arrangement (27, 29) connectable to a voltage supply; a scintillator (21, 35) adapted to emit UV light in dependence on being struck by electrons; and an exit window (19) transparent to UV light. Visible light is, during conversion, entered through the entrance window and irradiates the photocathode. Photoelectrons released from the photocathode is, by means of an electrical field created by the electrode arrangement, drifted towards the scintillator, where they are converted into scintillating light, which is output through the exit window. The converter is advantageously arranged in front of a gaseous based two-dimensional UV light detector for detection of visible light.

### TECHNICAL FIELD OF THE INVENTION

The present invention relates to an apparatus and method for conversion of visible light to UV light, and to an apparatus and method for detection of visible light by conversion of the visible light to UV light followed by detection, particularly gaseous based detection, of said UV light.

### DESCRIPTION OF RELATED ART AND BACKGROUND OF THE INVENTION

Gaseous detectors for UV photons developed by Seguinot et al. and independently by Bogomolov et al. opened a new field of applications. Such detectors have a quantum efficiency (QE) for very ultra-violet (VUV) photons similar or even higher to vacuum PMT's. In contrast to PMT's, they are cheap, simple, have a high position resolution, can easily cover a large area, and are insensitive to magnetic fields.

The success of this type of detectors encouraged several groups on attempting to develop gaseous detectors sensitive also to visible light. It turned out, however, to be an extremely difficult task. The main difficulties are associated with high cleanliness requirements, photon and ion feedback and photocathode aging and instability with time.

### SUMMARY OF THE INVENTION

In attempts to solve this problem the present inventors have recently tested a micro-pattern capillary plate as an amplification structure in such a gaseous based UV light detector. Due to the geometry of the capillary plate, it efficiently suppresses feedback of photons and ions.

However, as all micro-pattern capillary plates have a low gain, a double stage is needed to detect single electrons. Two stages, however, are too complicated to manufacture and do not work reliably on a large area (due to e.g. defect channels).

The inventors then realized that a conventional gaseous based UV light detector can be utilized for the detection of visible light if it is provided with a converter in front thereof, which converts visible light into UV light.

Accordingly, it is an object of the present invention to provide an apparatus and a method, respectively, for conversion of visible light to UV light.

It is in this respect a particular object of the invention to provide such apparatus and method, which can be used with a large-area UV light detector to image an incident visible light distribution.

A further object of the invention is to provide such apparatus and method, which fulfill cleanliness requirements, and which eliminate or reduce problems concerned with photocathode aging and instability with time.

Yet a further object of the invention is to provide such apparatus and method, which avoid photon and ion feedback.

Still a further object of the invention is to provide such apparatus and method, which provide for an effective conversion with high sensitivity and low noise.

Yet a further object of the present invention is to provide such apparatus and method, which are effective, fast, accurate, reliable, and of low cost.

Still a further object of the present invention is to provide an apparatus and a method, respectively, for detection of visible light, which include conversion of visible light to UV light followed by detection of the UV light.

These objects among others are, according to the present invention, attained by apparatus and methods as claimed in the appended claims.

Advantages of the present invention include that high cleanliness requirements can be fulfilled, photon and ion feedback is avoided and problems regarding photocathode aging and instability with time are reduced.

A further advantage of the invention is that it provides for the use of sensitive large-area detectors to a low cost.

Further characteristics of the invention and advantages thereof will be evident from the following detailed description of preferred embodiments of the invention, which are shown in the accompanying drawings.

### BRIEF DESCRIPTION OF THE DRAWINGS

The present invention will become more fully understood from the detailed description of embodiments of the present invention given hereinbelow and the accompanying FIGS. 1-3, which are given by way of illustration only, and thus are not limitative of the invention.

FIG. 1 illustrates schematically, in a cross sectional view, a first embodiment of an apparatus for two-dimensional detection of visible light according to the present invention, the apparatus including a light converter for conversion of visible light to UV light and a conventional multi-wire proportional chamber provided with a CsI photocathode for detection of the UV light.

FIG. 2 illustrates schematically, in a cross sectional view, a second embodiment of the inventive apparatus for two-dimensional detection of visible light.

FIG. 3 illustrates schematically, in a cross sectional view, a third embodiment of the inventive apparatus for two-dimensional detection of visible light.

### DETAILED DESCRIPTION OF PREFERRED EMBODIMENTS

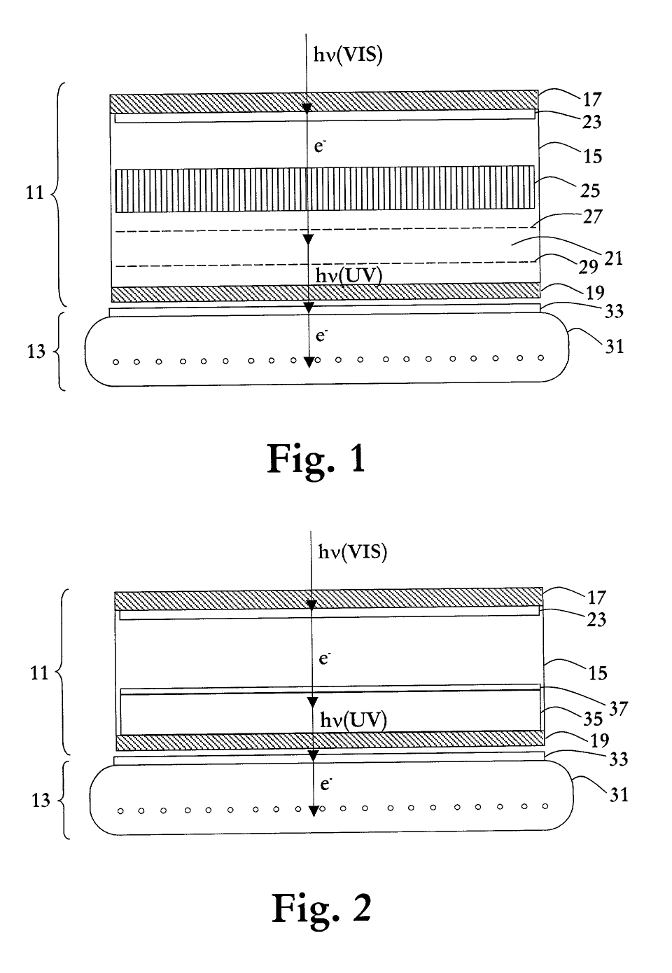

With reference to FIG. 1, which schematically, and in a sectional view, illustrates an inventive detector apparatus, a first embodiment of the present invention will be discussed in more detail.

The apparatus includes two parts: a light converter 11 for converting incident visible light to UV light; and a UV light detector 13 for detection of the UV light output from converter 11. In FIG. 1 incident visible light is indicated by an arrow denoted hv(VIS) and output UV light is indicated by an arrow denoted hv(UV)

Light converter 11 includes a sealed chamber 15 provided with an entrance window 17 transparent to visible light and an exit window 19 transparent to UV light. Thus, entrance window 17 is preferably made of glass, whereas exit window is preferably made of CaF₂, MgF or quartz. Sealed chamber 15 is, during use, filled with a scintillating gas 21 such as e.g. xenon, argon or nitrogen at a suitable pressure, e.g. 1 atm.

Further, sealed chamber 15 houses a photocathode 23, a capillary plate 25 and two mesh electrodes 27, 29.

The photocathode 23 is arranged behind window 17 and is arranged such that visible light entered through entrance window 17 can impinge on the photocathode 23. Further, photocathode 23 is sensitive to visible light and is thus adapted to release photoelectrons in dependence on being irradiated by visible light. Examples of such photocathodes include those made of ScCs, SbCs, and bi-alkali materials, as e.g. K₂CsSb and KNaSb.

The photoelectrons are indicated by an arrow denoted e⁻ in FIG. 1.

The photocathode 23 shall be thin such that photoelectrons can be released from a first surface thereof, a back surface, in dependence on light impinging on a second surface thereof, a front surface, (i.e. the surface facing entrance window 17), wherein the first and second surfaces are opposite to each other.

The capillary plate 25 is located between photocathode 23 and mesh electrodes 27, 29, and its major purpose is, in the illustrated embodiment, to suppress scintillating light emitted in the gas 21 between the mesh electrodes 27, 29 from reaching photocathode 23 and to cause further electrons to be released. Such light feedback could interfere adversely with the light conversion function of light converter 11. Thus, capillary plate 25 is a light attenuator.

The capillary plate 25 is comprised of an array of glass capillary tubes through which photoelectrons can pass. A thin metallic layer structure may be arranged at the bottom of the capillary tubes, i.e. adjacent mesh electrodes 27, 29, and possibly also at the top of the capillary tubes, i.e. adjacent to photocathode 23. Such layers are preferably provided with a plurality of through holes aligned with the respective capillary tubes.

The two mesh electrodes 27, 29, which constitute a parallel-plate mesh chamber, are together with the photocathode and, optionally, any metallic layer structures at the bottom and top of the capillary plate 25 connectable to a voltage supply unit (not illustrated in FIG. 1). These electrodes/metallic layers are, during use, held at electrical potentials such that a weak electric field is created between photocathode 23 and electrode 27, which drifts photoelectrons released from photocathode 23, through the capillary plate and towards electrode 27, and such that a stronger electric field is created between electrodes 27 and 29, which accelerates photoelectrons entered into the parallel-plate mesh chamber, and causes the photoelectrons to interact with the scintillating gas 21, whereby scintillating UV-VUV light is emitted, which is output through exit window 19 (indicated by the arrow hv(UV) in FIG. 1). The distance between the mesh electrodes 27, 29 is preferably between 10 μm and 10 cm, and is typically about a millimeter.

The entrance window 17, the photocathode 23, the electrode arrangement 27, 29, and the exit window 19 extend in planes substantially parallel with each other (perpendicular to the FIG. 1 cross section), such that the light converter 11, during use, converts visible light entered through said entrance window at an entrance position to UV light, which exits through said exit window at an exit position, where the entrance position is substantially uniquely determined by the exit position. Such imaging functionality is indicated by the aligned row of arrows in FIG. 1, i.e. those denoted hv(VIS), e^{—}, and hv(UV).

It shall, however, be appreciated that a certain degree of smoothing is unavoidable since the scintillating light is emitted isotropically. By proper design of the converter such smoothing can be strongly reduced.

It shall further be appreciated that the capillary plate may be dispensed with to the cost of an increased feedback.

Furthermore, a collimator (not illustrated) may be placed between mesh electrode 29 and exit window 19 to collimate the emitted UV light, to thereby increase the position resolution. Such collimator may alternatively be located at the exterior surface of exit window 19.

In another version of the light converter the capillary plate 25 is replaced by a protective layer, preferably a thin metallic layer, which may be formed on the back surface of the photocathode 23, i.e. the surface from where the photoelectrons are released.

It shall still further be appreciated that the mesh electrodes 27, 29 may be dispensed with if an electric field is created within the capillary plate 25, which causes scintillating light to be emitted therein. However, in such an approach the capillary plate is less effective and thus a much narrower dynamic range is obtained.

The UV light detector 13 comprises preferably a multi-wire proportional chamber 31 provided with a photocathode 33 of e.g. CsI for two-dimensional detection of UV light. Chamber 31 is preferably filled, during use, with CH₄ or a mixture of CH₄ and Ar at a pressure of about 1 atm.

Instead of such arrangement, the photocathode can be replaced by a gas emitting electrons when being irradiated by UV light, e.g. any of TMAE, TMA and TEA. To achieve avalanche amplification such gas is mixed with a gas suitable for avalanche amplification, e.g. methane or ethane.

The detector 13 and light converter 11 are arranged such that the UV light output from light converter 11 can enter detector 13 and be detected therein. Thus, the combined light converter and detector apparatus 11, 13 provides for detection of visible light.

It shall be appreciated that other kind of gaseous based detector, which involves electron avalanche amplification, can be used with light converter 11. Actually, any other kind of UV light detector, such as e.g. a UV sensitive PMT, film CCD etc. may be used together with the light converter 11.

With reference next to FIG. 2, which schematically, and in a sectional view, illustrates a detector apparatus, a second embodiment of the present invention will be described.

The FIG. 2 apparatus is similar to the FIG. 1 apparatus, and differs as regards the following components only.

Instead of having a scintillating gas in chamber 15 a solid scintillator 35 is provided adjacent to the exit window. The scintillator is preferably a thin plate, preferably between 10 μm and 1 cm thick, and typically about 200 μm thick, and made of any of KMgF₃. BaF₂, KCaF₃, K₁₋ₓRbₓF, RbF, CsCl, and CsBr, and may contain a plurality of scintillator elements arranged in an array.

Instead of using a capillary plate as a light attenuator a thin metallic layer 37 (thickness preferably in the range 10 nm-10 μm, and typically about 0.5 μm), which is opaque to UV light and transparent to electrons, is formed on the front surface of the scintillator plate 33, i.e. the surface which is facing the photocathode 23.

The mesh electrodes are dispensed with and the electric field needed for acceleration of electrons is achieved by means of connecting the photocathode 23 and the scintillator plate 35, or optionally the metallic layer 37, to appropriate electric potentials. For this purposes the apparatus includes a voltage supply unit (not illustrated).

The sealed chamber 15, which houses photocathode 23 and in which the photoelectrons are accelerated towards the scintillator plate 35 is, during use, at vacuum.

It shall be appreciated that the vacuum chamber is used to fulfill cleanliness requirements for the photocathode as such a photocathode 23 is sensitive to small impurities in any gas in contact with it, which impurities cause degradation of the quantum efficiency of the photocathode with time.

Nevertheless, if any cleanliness requirements could be fulfilled in other manner, e.g. by a protective layer, the sealed vacuum chamber could be dispensed with.

The vacuum chamber is, however, preferably also used as an acceleration chamber, wherein the kinetic energy of the drifted electrons is considerably increased, to thereby cause a larger amount of UV light to be emitted within the scintillator plate 33.

Furthermore, as in the FIG. 1 embodiment a collimator (not illustrated) may be adapted to collimate light emitted in the scintillator. Such collimator may be arranged between scintillator 35 and exit window 19, or outside of chamber 15, e.g. mounted on the exterior surface of exit window 19.

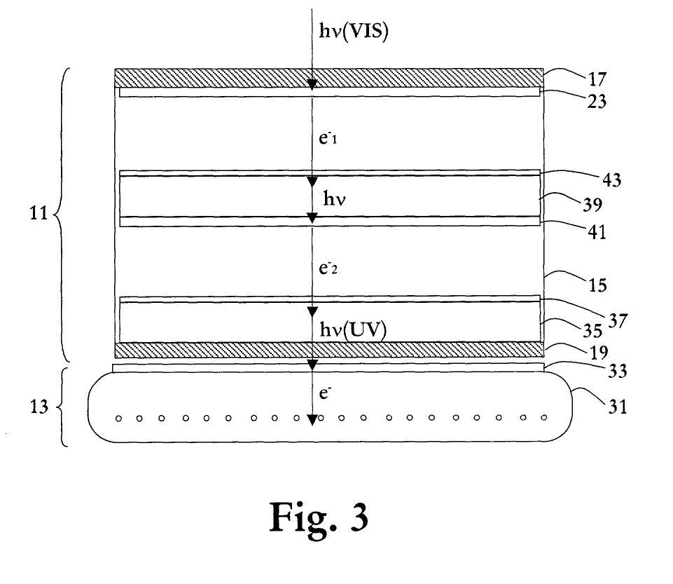

With reference next to FIG. 3, which schematically, and in a sectional view, illustrates a detector apparatus, a third embodiment of the present invention will be described. This embodiment apparatus is similar to the FIG. 2 apparatus, but uses a double scintillator stage and differs thus from the FIG. 2 embodiment as regards the following.

The apparatus of FIG. 3 comprises a second scintillator plate 39, a second light attenuator in the form of a metallic layer 43 and a second photocathode 41 arranged in sealed vacuum chamber 15 between photocathode 23 and scintillator 35.

A voltage is, during use, applied over photocathode 23 and scintillator 39 such that photoelectrons e³¹₁ released from photocathode 23 are accelerated towards scintillator 39. These electrons are absorbed in scintillator 39 and as a consequence thereof scintillating light hv is emitted.

Photocathode 41 is adapted to release photoelectrons e³¹₂ in dependence on being irradiated by light emitted from scintillator 39.

Further, a voltage is, during use, applied over photocathode 41 and scintillator 35 such that photoelectrons e³¹₂ released from photocathode 41 are accelerated towards scintillator 35. These electrons are absorbed in scintillator 39 and as a consequence thereof scintillating UV light hv(UV) is emitted.

By means of such double-step solid scintillator chamber an increased intensity of the emitted UV light may be obtained.

The main advantage of light converter 11 is that the photocathode is kept in a sealed chamber, which has only a few feedthroughs and does not contain any outgassing materials. This ensures a high degree of cleanliness. As a result, the photocathodes have high quantum efficiency, are stable in time and do not show any sign of aging.

The converter 11, especially the one using a gas scintillator (FIG. 1 embodiment), may have a large sensitive area because there are no mechanical constrains on the window size.

Further, all embodiments are practically insensitive to magnetic fields.

Note that multiple feedthroughs for position measurements are located only in the readout chamber (flushed with the gas) of the detector 13 and this not only simplifies the design but also reduces cost.

An other practical consequence of the design (i.e. having a light converter in front of a UV detector) is that the light converter may be fabricated to a low cost, and can then be combined with a standard photosensitive (UV) gaseous detector. Large area wire chambers have for years proved to be reliable devices. In combination with the light converter of the present invention it may open a field for new applications. At low gain operation, large area capillaries have much less risk of failing and there is no charging up effect.

In another version of the invention (not illustrated) a light converter of above said kind is modified to emit visible light, to allow for light amplification instead of light frequency conversion. To this end, the scintillator of the FIGS. 1-3 embodiments has to be replaced by a scintillator emitting visible light, e.g. a scintillator made of NaI.

It shall be remembered that the light converter can be used with other light detectors than the ones depicted above. Particularly, use of micro-pattern detectors for the readout is feasible.

It will be obvious that the invention may be varied in a plurality of ways. Such variations are not to be regarded as a departure from the scope of the invention. All such modifications as would be obvious to one skilled in the art are intended to be included within the scope of the appended claims.

1. An apparatus for conversion of visible light to UV light comprising:
an entrance window transparent to visible light;
a first photocathode adapted to release photoelectrons in dependence on being irradiated by visible light, and arranged such that visible light entered through said entrance window can impinge on said first photocathode;
an electrode arrangement connectable to a voltage supply for drift of photoelectrons released from said first photocathode;
a first scintillator adapted to emit UV light in dependence on being struck by electrons, and arranged such that photoelectrons drifted by means of said electrode arrangement can strike said first scintillator; and
an exit window transparent to UV light, said exit window being arranged such that UV light emitted by said first scintillator can exit through said exit window.

2. The apparatus as claimed in claim 1 comprising a light attenuator arranged between said first photocathode and said first scintillator for attenuation of light emitted by said first scintillator in a direction towards said first photocathode.

3. The apparatus as claimed in claim 2 wherein said light attenuator is a capillary plate.

4. The apparatus as claimed in claim 2 wherein said light attenuator is a metallic layer.

5. The apparatus as claimed in claim 1 further comprising a sealed chamber housing said first photocathode.

6. The apparatus as claimed in claim 5 wherein said sealed chamber houses said electrode arrangement and said first scintillator, and wherein said first scintillator is a gas, preferably a noble gas.

7. The apparatus as claimed in claim 1 wherein said first scintillator is a solid, preferably KMgF₃, BaF₂, KCaF₃, K₁₋ₓRbₓ,F, RbF, CsCl, or CsBr.

8. The apparatus as claimed in claim 7 further comprising a sealed chamber housing said first photocathode, wherein said chamber, during use, contains vacuum, in which said photoelectrons are drifted towards the solid first scintillator.

9. The apparatus as claimed in claim 1 further comprising a second scintillator and a second photocathode, wherein
said electrode arrangement is adapted to drift photoelectrons released from said first photocathode towards said second scintillator;
said second scintillator is adapted to emit light in dependence on being struck by said photoelectrons;
said second photocathode is adapted to release photoelectrons in dependence on being irradiated by light emitted from said second scintillator, and arranged such that light emitted from said second scintillator can impinge on said second photocathode; and
said electrode arrangement is further adapted to drift photoelectrons released from said second photocathode towards said first scintillator.

10. The apparatus as claimed in claim 9 further comprising a second light attenuator, wherein
said second light attenuator is arranged between said first photocathode and said second scintillator for attenuation of light emitted by said second scintillator in a direction towards said first photocathode; and
said first light attenuator is arranged between said second photocathode and said first scintillator for attenuation of light emitted by said first scintillator in a direction towards said second photocathode.

11. The apparatus as claimed in claim 1 wherein each scintillator includes an array of scintillator elements.

12. The apparatus as claimed in claim 1 wherein the electrode arrangement include a parallel-plate mesh chamber.

13. The apparatus as claimed in claim 1 further comprising a collimator adapted to collimate the emitted UV light.

14. The apparatus as claimed in claim 1 wherein each photocathode is adapted to release photoelectrons from a first surface thereof, a back surface, in dependence on light impinging on a second surface thereof, a front surface, said first and second surfaces being opposite to each other.

15. The apparatus as claimed in claim 14 wherein said entrance window, each photocathode, said electrode arrangement, and said exit window extend in planes substantially parallel with each other, such that said apparatus, during use, converts visible light entered trough said entrance window at an entrance position to UV light, which exits through said exit window at an exit position, where the entrance position is substantially uniquely determined by the exit position.

16. The apparatus as claimed in claim 15 wherein said apparatus is adapted to be used in front of a two-dimensional UV light detector, preferably a gaseous based detector such as e.g. a detector of the kind that includes a multi-wire proportional chamber, to provide for two-dimensional imaging of incident visible light.

17. An apparatus for detection of visible light comprising:
an apparatus for conversion of visible light to UV light as claimed in claim 1; and
a detector for detection of UV light arranged such that UV light, which exits through the exit window of said conversion apparatus, enters said detector and is detected therein.

18. An apparatus as claimed in claim 17 wherein said UV light detector is a gaseous based detector, preferably a detector of the kind that includes a multi-wire proportional chamber, or other kind of detector which involves electron avalanche amplification.

19. A method for conversion of visible light to UV light in a light converter comprising the steps of:
entering visible light through an entrance window of said light converter, said entrance window being transparent to visible light;
creating photoelectrons by means of irradiating a photocathode of said light converter with said entered visible light, said photocathode being adapted to release photoelectrons in dependence on being irradiated by visible light;
drifting said created photoelectrons by means of applying an electrical field within said light converter;
creating scintillating UV light by means of arranging said drifted photoelectrons to strike a scintillator of said light converter, said scintillator being adapted to emit UV light in dependence on being struck by electrons; and
making said created UV light to exit said light converter through an exit window thereof, said exit window being transparent to UV light.

20. The method as claimed in claim 19 wherein created scintillating UV light propagating in a direction towards said photocathode is attenuated by means of a light attenuator of said light converter.

21. The method as claimed in claim 19 wherein scintillating UV light is created by means of arranging said drifted photoelectrons to strike a scintillating gas, preferably a noble gas, housed together with said photocathode in a sealed chamber of said light converter.

22. The method as claimed in claim 19 wherein scintillating UV light is created by means of arranging said drifted photoelectrons to strike a scintillating solid, preferably KMgF₃, BaF₂, KCaF3, K₁₋ₓ,Rbₓ,F, RbF, CsCl, or CsBr.

23. The method as claimed in claim 22 wherein said created photoelectrons are drifted in a sealed vacuum chamber of said light converter, where said chamber also houses said photocathode.

24. The method as claimed in claim 19 wherein the electrical field is applied within an electrode arrangement of said light converter, said electrode arrangement particularly comprising a parallel-plate mesh chamber.

25. A method for detection of visible light comprising the steps of:
converting visible light to UV light in a light converter in accordance with the method as claimed in claim 19; and
detecting the UV light made to exit said light converter in a UV light detector.

26. The method as claimed in claim 25 wherein the UV light is detected in a gaseous based detector, preferably a detector of the kind that includes a multi-wire proportional chamber, or other kind of detector which involves electron avalanche amplification.

27. An apparatus for conversion of visible light comprising:
an entrance window transparent to visible light;
a photocathode adapted to release photoelectrons in dependence on being irradiated by visible light, and arranged such that visible light entered through said entrance window can impinge on said photocathode;
an electrode arrangement connectable to a voltage supply for drift of photoelectrons released from said photocathode;
a scintillator adapted to emit light in dependence on being struck by electrons, and arranged such that photoelectrons drifted by means of said electrode arrangement can strike said scintillator; and
an exit window transparent to light, said exit window being arranged such that light emitted by said scintillator can exit through said exit window, wherein
said apparatus is adapted to amplify visible light entered through said entrance window by means of said conversion.
